(19) United States
(12) Patent Application Publication
(10) Pub. No.: US 2026/0024394 A1
(43) Pub. Date: Jan. 22, 2026

(54) Device for Counting Coins

(71) Applicant: Sarah R. Fletcher, Charlestown, RI (US)

(72) Inventor: Sarah R. Fletcher, Charlestown, RI (US)

(21) Appl. No.: 18/779,851

(22) Filed: Jul. 22, 2024

(51) Int. Cl. G07D 9/00

(52) U.S. Cl. CPC G07D 9/002

(57) ABSTRACT

A device that receives disk-shaped objects, such as coins or game chips, indicates an accumulated value of a set of disks by measuring the height of the stacked disks. In an example embodiment, the apparatus is a planar form designed to be folded into a “V” shape, providing a V-shaped channel configured to hold coins. A protruding shelf is formed by folding a section of the apparatus in the opposite direction of the main fold. At least one indicator line marks the height and currency value of a stack of coins.

### TECHNICAL FIELD

The present disclosure relates to devices for counting disk-shaped objects, including coins.

### BACKGROUND

Devices for counting and sorting coins, chips, or other small disks range from simple stacking devices to digital electronic machines. Some devices sort and orient coins or game chips for wrapping. These may be sized for various denominations of coin, or various values or characteristics of game chips.

Sorted coins are often placed in coin-wrapper sleeves for depositing at a bank, but these sleeves are difficult to manipulate. They also do not have a mark that indicates an accumulated currency value. A simple tool would enable stacking and enumerating coins or game chips for placing by hand into coin-wrappers or other holders. Game chips, coins, tokens are disk-shaped objects of equal thickness. For the purpose of clarity, disk-shaped objects of equal thickness may be referred to as coins, chips or tokens in this disclosure although any disk-shaped object may suffice.

### SUMMARY

A device that receives disk-shaped objects, such as coins or game chips, indicates an accumulated value of a set of disks by measuring the height of the stacked disks. In an example embodiment, the apparatus is a planar form designed to be folded into a “V” shape to hold coins. A protruding shelf is formed by folding a section of the apparatus in the opposite direction of the main fold. Coins or chips rest on the shelf at one end. In an embodiment, at least one indicator line marks the height and currency value of a stack of coins. The device is designed to facilitate sliding coins or other disk-shaped objects into a standard coin-wrapper or other holder, and can be sized to work with any coin denomination or disk size. Once the coins are loaded into the device to reach the indicated value, they can be slid into a provided coin wrapper or other holder.

Any denomination of any coin may be indicated by the markings. The example embodiment described herein covers an embodiment used for coins, but the invention is designed to work with any disk-shaped object. Chips, tokens or any set of disk-shaped objects having equal thickness may be stacked and counted according to the height of a stack and may be used with the embodiment of the disclosure.

The following drawings are designed to illustrate, not limit, the invention.

### BRIEF DESCRIPTION OF THE DRAWINGS

FIG. 1 is side, perspective view of the embodiment in a flat configuration.

FIG. 2 is side, perspective view of the embodiment in its folded aspect.

FIG. 3 is side, perspective view of the embodiment showing coins stacked to an indicator line.

FIG. 4 is is side, perspective view of the embodiment shown in use.

FIG. 5 is a detailed, plan view of the embodiment showing value indicators.

FIG. 6 is a detailed, plan view of the embodiment showing additional value indicators.

### DESCRIPTION

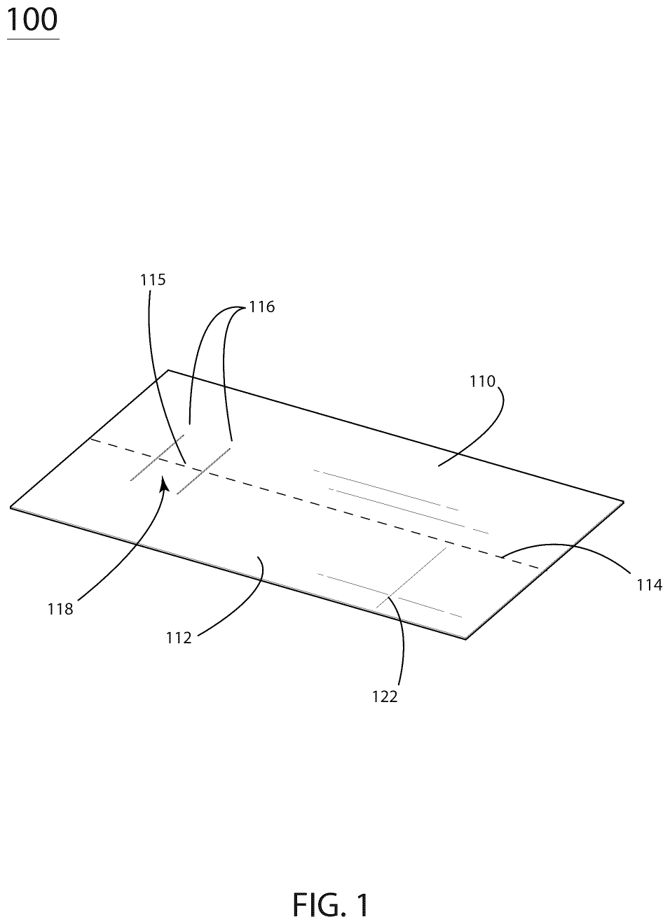

FIG. 1 100 shows an example embodiment in a flat configuration. A fold line 114 indicates where to fold the embodiment to make a two-sided (110, 112) holder. The apparatus is folded in a first direction along fold line 114 and in a second direction along fold line 115. Fold line 115 resides between two slots 116. When fold line 115 is folded in the opposite direction of fold line 114, it forms a protrusion, also referred to as a shelf 118.

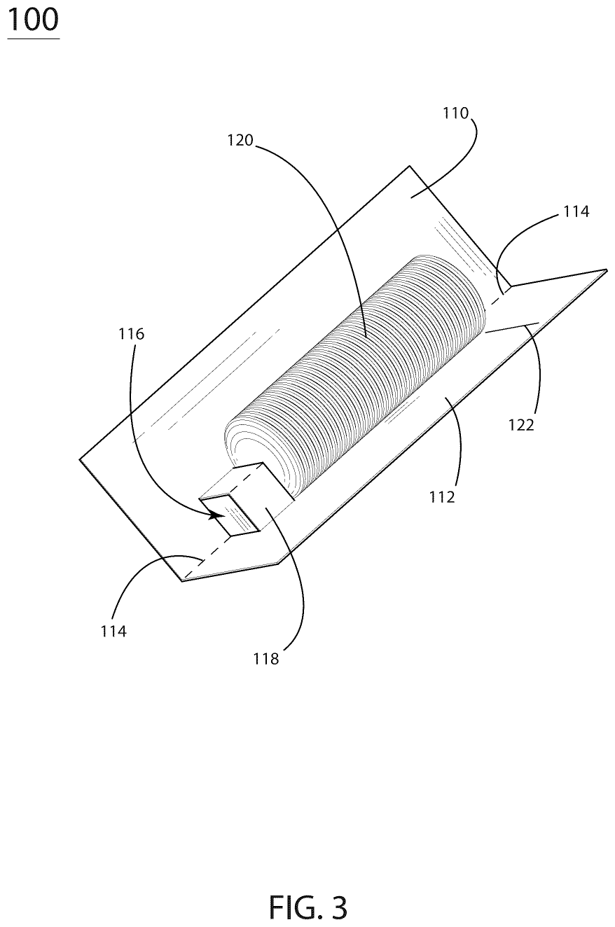

At least two notches 116 indicate where to fold, in the opposite direction of the fold 114, to create the shelf 118. This shelf serves as a base for holding a stack of coins. 122 is an indicator line, which will be explained in detail in FIG. 3.

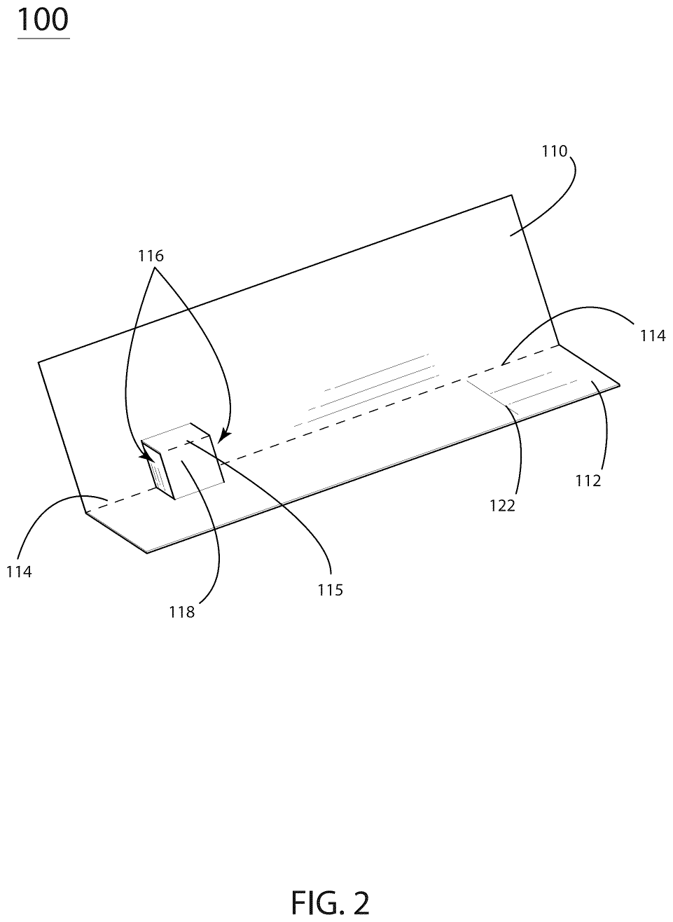

FIG. 2 shows the apparatus 100 folded for use. Folding it along fold line 114 creates two sides 110 and 112 and forms the device into a V-shape, creating a V-channel. Fold line 115 is folded in the opposite direction of fold line 114, forming the protrusion 118.

FIG. 3 illustrates an example use, with a quantity of quarters 120 stacked between the halves 110 and 112, resting against the protrusion/shelf 118. An indicator is a line 122 showing a quantity of quarters. In this case, the quarters 120 total US $10. Like reference numbers refer to like components. Reference numbers not mentioned detailed descriptions are shown for reference.

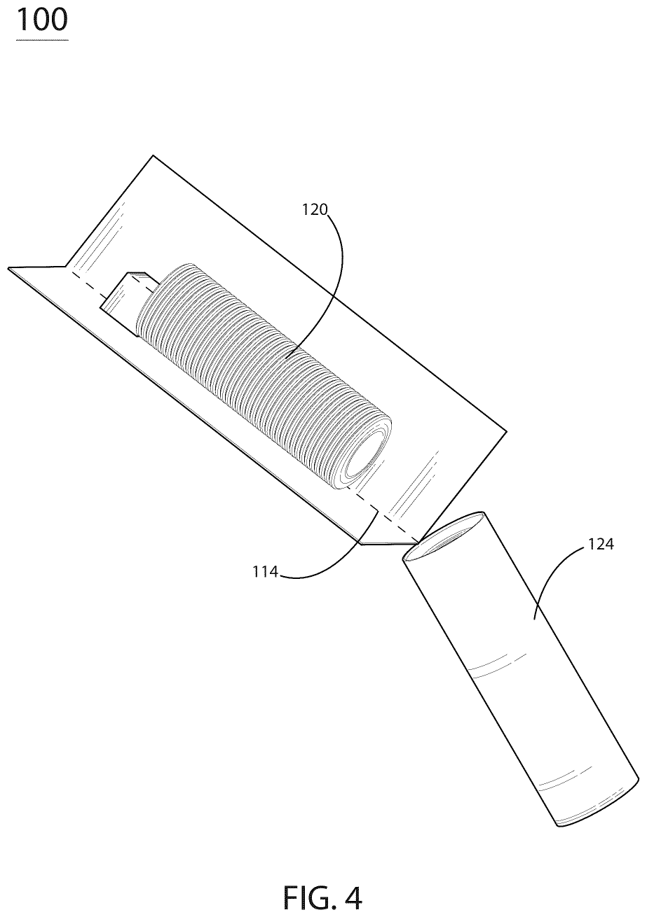

FIG. 4 shows an example embodiment in use. After stacking the coins, the embodiment is tilted to slide the coins 120 along the V-channel fold 114 into a provided coin-wrapper 124.

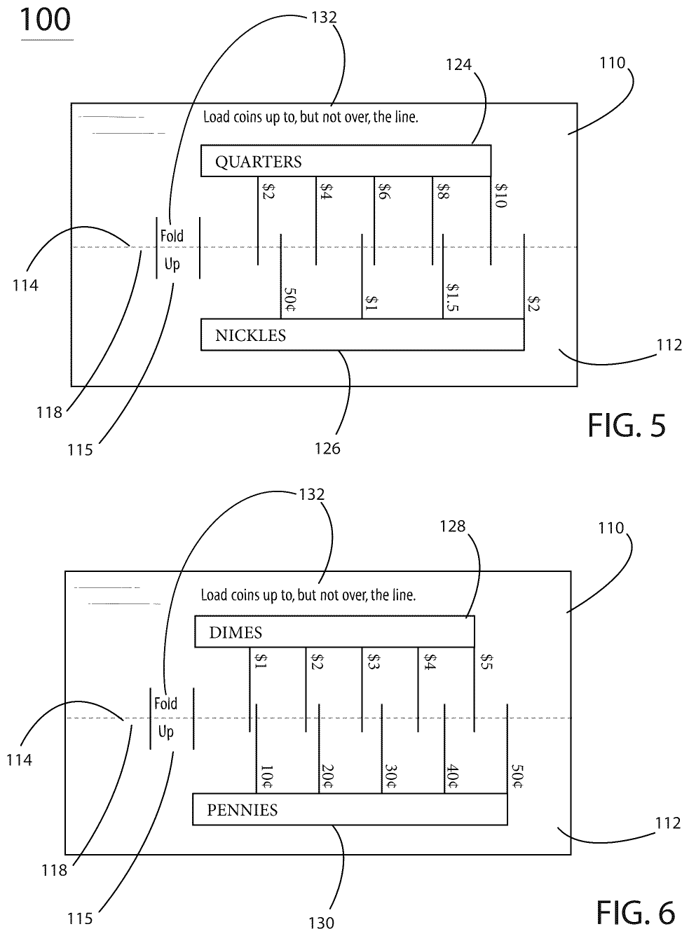

FIG. 5 is an example embodiment showing, on one side 110, a printed indicator 124 of currency values of collected quarters totaling US $2, $4, $6, $8 and $10 when quarters are stacked on the shelf 118 of the folded apparatus. A similar indicator 126 on the other side 112 of the fold works for nickels. Instructions 132 indicate how to load the coins as well as how to fold the shelf.

FIG. 6 is another example embodiment showing, on one side 110, a printed indicator 128 of currency values of collected dimes totaling US $1, $2, $3, $4 and $5 when dimes are stacked upon the shelf 118 of the folded apparatus. A similar indicator 130 works for pennies in various increments of currency value. Instructions 132 indicate how to load the coins as well as how to fold the shelf. One skilled in the art understands that the information in FIG. 5 may be printed on the back of an apparatus that has the information in FIG. 6 printed on the front of the apparatus.

One skilled in the art understands that the term coins, or terms referring to specific coins, of any denomination of any country may be represented on the embodiment, with any value increments. Furthermore any token, chip or disk-shaped object having a substantially equal thickness from one disk-shaped object to another, may be counted by the height of a stack of such disk-shaped objects and so may be used with the present embodiment without deviating from the structure of the embodiment.

These embodiments should not be construed as limiting.

1. An apparatus for assisting in counting disk-shaped objects comprising:
a piece of flat material having a first fold line and a second fold line; and
at least two slots surrounding said second fold line; wherein
said first fold line is folded in a first direction and said second fold line is folded in a second direction to form a V-channel with a protrusion.

2. The apparatus of claim 1 further comprising:
at least one demarcation indicating a distance from said protrusion; wherein
the distance from said protrusion to said demarcation is the height of a set of disks that when stacked in said V-channel, resting against said protrusion, total a given value.

3. The apparatus of claim 1 wherein the disks are coins.

4. A method for using the apparatus of claim 1, the method comprising:
forming a V-channel by folding said piece of flat material along said first fold line in a first direction; and
forming a protrusion by folding said piece of flat material along said second fold line in a second direction; and
resting at least a first disk in said V-channel, against said protrusion.

5. The method of claim 4 further comprising:
stacking disks in said V-channel, against said at least first coin; and
aligning said V-channel with a provided wrapper configured to hold said disks; and
tilting said V-channel to feed said disks into said provided cylinder.

6. A method for using the apparatus of claim 2, the method comprising:
forming a V-channel by folding said piece of flat material along said first fold line in a first direction; and
forming a protrusion by folding said piece of flat material along said second fold line in a second direction; and
resting at least a first coin in said V-channel, against said protrusion.

7. The method of claim 6 further comprising:
stacking disks in said V-channel, against said at least first coin, until said stacked disks cover the distance between said protrusion to said demarcation; and
aligning said V-channel with a provided cylinder configured to hold said disks; and
tilting said V-channel to feed said disks into said provided cylinder.
